(19) United States
(12) Patent Application Publication
(10) Pub. No.: US 2024/0420219 A1
(43) Pub. Date: Dec. 19, 2024

(54) SYSTEM AND METHOD FOR PROVIDING A VIRTUAL ASSORTMENT INTERFACE OF COMPONENTS IN INVENTORY IN AN E-COMMERCE ENVIRONMENT

(71) Applicant: ASP CLIPS, INC., Bertram, TX (US)

(72) Inventor: Scott Lindquist, Bertram, TX (US)

(21) Appl. No.: 18/747,675

(22) Filed: Jun. 19, 2024

Related U.S. Application Data
(60) Provisional application No. 63/521,804, filed on Jun. 19, 2023.

(51) Int. Cl. G06Q 30/0601

(52) U.S. Cl. CPC G06Q 30/0633; G06Q 30/0643

(57) ABSTRACT

A system and a method for providing a virtual assortment interface of components in inventory in an e-commerce environment is disclosed. The system creates the virtual assortment interface corresponding to a storage device having a plurality of drawers, each drawer including multiple compartments for storing components therein. The virtual assortment interface presents a virtual assortment of the components in the inventory and provides data corresponding to the number of the compartment, type of the component, serial number and available quantity of the components in each compartment. The system allows a user to view one or more drawers on the virtual assortment interface, select the components and add the components in a shopping cart for executing a purchase transaction. Upon executing the purchase transaction, a retailer or distributor fulfils the purchase by shipping the components to the user.

The present application claims the benefit of U.S. Provisional Application No. 63/521,804 filed Jun. 19, 2023; all of which is incorporated herein by reference.

### TECHNICAL FIELD

The present disclosure relates to the field of electronic commerce (e-commerce), and in particular, relates to a system and a method for providing a virtual assortment interface of components in inventory in an e-commerce environment.

### DESCRIPTION OF THE RELATED ART

It is known that a virtual shopping cart in electronic commerce (e-commerce) indicates a process of selecting one or more components or items for prospective purchase. Typically, a user visits the e-commerce website, selects one or more components by performing a search using the name or unique code associated with the component, and adds representations of the component into the virtual shopping cart. The components include, but not limited to, mechanical parts, apparel, virtual goods, among others.

Several methods for ordering the components or items on e-commerce websites have been disclosed in the past. One such example is disclosed in a U.S. Pat. No. 10,121,176, entitled “Methods and systems for simplifying ordering from online shops” (“the '176 Patent”). The '176 Patent discloses a method for simplifying ordering of products from online shops. This involves an agent server receiving captured contents of a product webpage from a client device and autonomously deriving product information therefrom. Alternatively, the agent service can receive a web address corresponding to a product webpage, and the agent server can visit the product webpage and capture its contents. The agent server then uses the derived product information to autonomously control ordering of the product for the user from an online shop, without requiring that the user have an account with the online shop, without requiring that the user enter personal and payment information in a check-out webpage of the online shop, without requiring that the user select a buy or shopping cart button associated with the online shop, and without requiring the online shop utilize an API to enable the agent server to interact with the online shop.

Another example is disclosed in a U.S. Pat. No. 9,092,817, entitled “Placing a purchase order using one of multiple procurement options” (“the '817 Patent”). The '817 Patent discloses a method and system for placing an order to purchase an item via the Internet. The order is placed by a user at a client system and received by a server system. The client system can display information identifying the item and, for each of multiple procurement options having information related to ordering the identified item, can display an indication of the procurement option such that selection of the displayed indication represents an ordering of the identified item using the information of the procurement option. In response to selection of a displayed indication, the client system can send to a server computer a request to order the identified item using the information of the procurement option for the selected indication.

Another example is disclosed in a U.S. Pat. No. 7,315,830, entitled “Method, system and computer program product for ordering merchandise in a global computer network environment” (“the '830 Patent”). The '830 Patent discloses an electronic shopping server that formats and sends an electronic page, having an integrated shopping basket with drag and drop functionality, from a virtual catalog to a plurality of clients. The server includes an e-sessions controller that manages and tracks each session with the clients, profile generator that identifies and authorizes each consumer to engage in the sessions, catalog selector responsive to on-demand requests for the contents and supporting data of each catalog page, and order processor that supports purchase requests. The e-sessions controller manages the sessions by causing each client to launch an electronic sessions application. The resident application includes a local sessions controller that brokers all client communications with the server and implements the instructions from the e-sessions controller. The resident application also includes an image generator for displaying an image of each item from the catalog page, descriptive data generator for displaying supporting data for each item, and an order panel generator for displaying a shopping basket that remains on the same page with the image at all times. An order initiator can be included to send a request for the server to create a facsimile of the shopping basket. An item adder and item remover cause items to be added/removed from the client's basket and, if included, server's basket upon executing a web page function. An order executor synchronizes the two shopping baskets and/or sends a request to purchase the items listed in the shopping basket. The shopping basket can be configured to travel with the consumer to receive input from various servers hosting different websites.

Yet another example is disclosed in a United States Publication No. 20160063435, entitled “Systems and methods for facilitating secure ordering, payment and delivery of goods or services” (“the '435 Publication”). The '435 Publication discloses a system and method for facilitating the secure order, payment and delivery of goods and/or services between various parties. The method may include receiving an order for goods or services at a management server; creating a waypoint for each address in the order; generating an identifier for each waypoint; transmitting the identifiers to a party associated with the waypoints; locating a courier to deliver the order; receiving identifier responses from the courier device at the waypoints, and matching the identifiers with the corresponding identifier responses to verify at least one of task completion and payment at the waypoints.

Although the above discussed disclosures are useful, they have few problems. For instance, when the user wishes to add more components/items to the virtual shopping cart, the user has to search for the components multiple times and add them individually to the virtual shopping cart. This is cumbersome and takes a considerable time to execute a purchase transaction.

Therefore, there is a need in the art to provide an improved system and a method for providing a virtual assortment interface of components in inventory in an e-commerce environment.

### SUMMARY

It is an object of the present subject matter to provide a virtual assortment interface and that avoids the drawback of known techniques.

It is another object of the present subject matter to provide a virtual assortment interface that replicates an actual storage device storing the components in inventory.

It is yet another object of the present subject matter to provide a unique shopping experience for the users while providing an improved assortment strategy for the retailers or distributors in managing the inventory.

In order to achieve one or more objects, the present subject matter provides a system for providing a virtual assortment interface of components in inventory in an e-commerce environment. The system creates the virtual assortment interface corresponding to a storage device having a plurality of drawers. Each drawer includes one or more compartments storing multiple components of different sizes and/or different make. The virtual assortment interface presents a virtual assortment of the components in the inventory, which is an actual replica of the storage device storing the physical components. The system obtains data corresponding to the number of the compartment, type of the component, serial number and available quantity of the components in each of the compartments.

In one aspect, when a user wishes to purchase one or more components, the system allows the user to view one or more drawers on the virtual assortment interface. The user selects the components by moving from one drawer to another on the virtual assortment interface and adds the components in a shopping cart for executing a purchase transaction. Upon executing the purchase transaction, a retailer or distributor fulfils the purchase by shipping the components to the user.

In one advantageous feature of the present subject matter, the system presents the virtual assortment interface, which is an image precisely replicating the drawers of the storage device storing the components. The user uses the image to select and add the components in the shopping cart. The virtual assortment interface avoids searching for the components every time to add them to the shopping cart.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGURES and examples are not meant to limit the scope of the present subject matter to a single embodiment, but other embodiments are possible by way of interchange of some or all of the described or illustrated elements and, further, wherein:

FIG. 1 illustrates an exemplary environment of a system for providing a virtual assortment interface of components in inventory in an e-commerce environment, in accordance with one embodiment of the present subject matter;

FIG. 2 illustrates a diagrammatic representation of the system, in accordance with one embodiment of the present subject matter;

FIG. 3 illustrates a block diagram of a client device, in accordance with one embodiment of the present subject matter;

FIG. 4 illustrates a perspective of a container/storage device containing a plurality of drawers, in accordance with one embodiment of the present subject matter;

FIG. 5 illustrates a representative interface presented to a retailer to add details of components, in accordance with one embodiment of the present subject matter;

FIG. 6 illustrates a virtual representation of the container, in accordance with one embodiment of the present subject matter;

FIGS. 7 and 8 illustrate the drawers showing different compartments having various components, in accordance with one embodiment of the present subject matter; and

FIG. 9 illustrates a method for providing a virtual assortment interface of components in inventory in an e-commerce environment, in accordance with one embodiment of the present subject matter.

### DETAILED DESCRIPTION

The detailed description set forth below in connection with the appended drawings is intended as a description of exemplary embodiments in which the presently disclosed disclosure can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed disclosure. However, it will be apparent to those skilled in the art that the presently disclosed disclosure may be practiced without these specific details. In some instances, well-known structures and devices are shown in block diagram form in order to avoid obscuring the concepts of the presently disclosed disclosure.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and/or firmware.

Embodiments of the present disclosure may be provided as a computer program product, which may include a non-transitory, machine-readable storage medium tangibly embodying thereon instructions, which may be used to program the computer (or other electronic devices) to perform a process. The machine-readable medium may include, but is not limited to, fixed (hard) drives, semiconductor memories, such as Read Only Memories (ROMs), Programmable Read-Only Memories (PROMs), Random Access Memories (RAMs), Erasable PROMs (EPROMs), Electrically Erasable PROMs (EEPROMs), flash memory or other types of media/machine-readable medium suitable for storing electronic instructions (e.g., computer programming code, such as software or firmware).

Various methods described herein may be practiced by combining one or more non-transitory, machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

Further, the term “module” may be software or hardware particularly programmed to receive an input, perform one or more processes using the input, and provide an output. The input, output, and processes performed by various modules will be apparent to one skilled in the art based on the present disclosure.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

It will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

Embodiments of the present disclosure present a system and method for providing a virtual assortment interface of components in inventory in an e-commerce environment. The system creates the virtual assortment interface corresponding to a storage device having a plurality of drawers, each drawer including multiple compartments for storing components therein. The virtual assortment interface presents a virtual assortment of the components in the inventory and provides data corresponding to the number of the compartment, type of the components, serial number and available quantity of the components in each compartment. The system allows a user to view one or more drawers on the virtual assortment interface, select the components and add the components in a shopping cart for executing a purchase transaction.

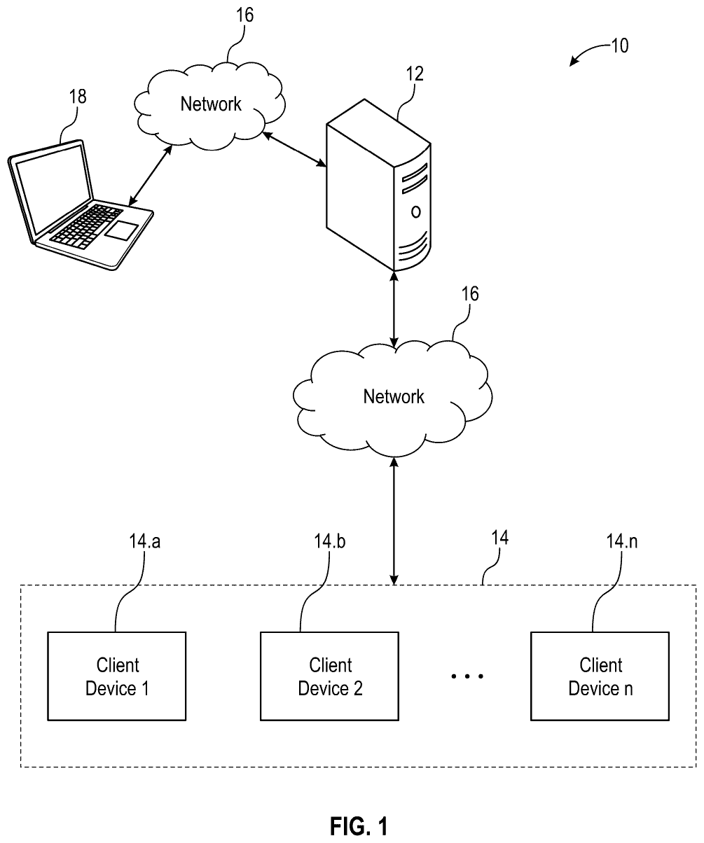

FIG. 1 illustrates an exemplary environment 10 of a system 12 for providing a virtual assortment interface of components in inventory in an e-commerce environment, in accordance with an embodiment of the present subject matter. System 12 includes a server or a database comprising an application to execute functions for providing a virtual assortment interface of components in inventory in an e-commerce environment. In one embodiment, system 12 operates as a standalone device or connects to other (e.g., networked) systems. A person skilled in the art appreciates that system 12 implements in any different computing systems, environments, and/or configurations such as a workstation, an electronic device, a mainframe computer, a laptop, and so on. In a networked deployment, system 12 operates in the capacity of a server or a client machine in server-client network environment, or as a peer machine in a peer-to-peer (or distributed) network environment. In one example, an e-commerce platform owner or a retailer operates system 12 for providing a virtual assortment interface of components in inventory in an e-commerce environment.

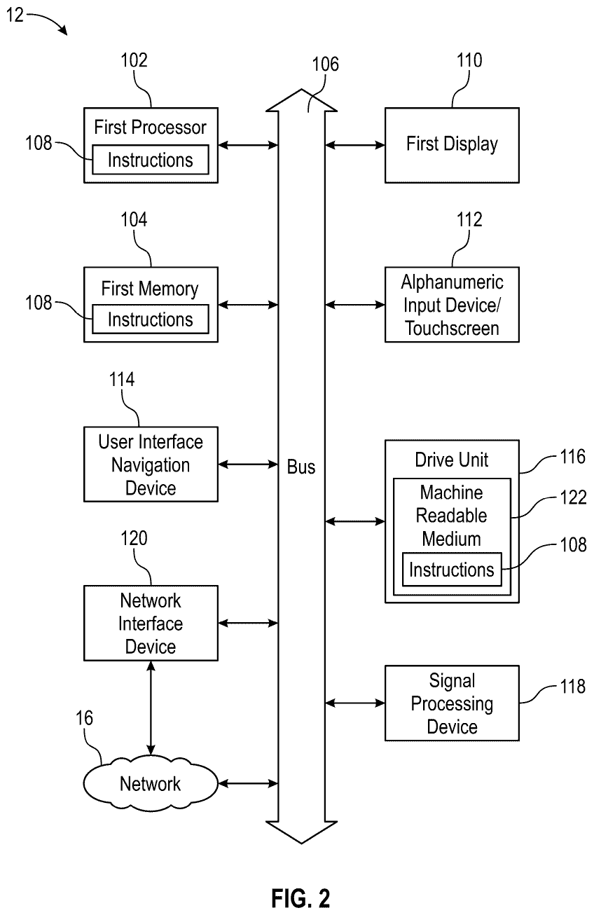

FIG. 2 shows a diagrammatic representation of system 12, in accordance with one embodiment of present subject matter. System 12 encompasses a first processor 102 (e.g., a central processing unit (CPU), a graphics processing unit (GPU) or both). First processor 102 electrically couples by a data bus 106 to a first memory 104. First memory 104 includes a volatile memory and/or a non-volatile memory. Preferably, first memory 104 stores instructions or software program 108 that interact with the other devices in system 12 and/or client devices 14 and a user device 18 as described below. In one implementation, first processor 102 executes instructions 108 stored in first memory 104 in any suitable manner. In one implementation, first memory 104 stores digital data indicative of documents, files, programs, web pages, etc. retrieved from one of client devices 14 and user device 18.

System 12 further includes a first display 110 (e.g., a liquid crystal display (LCD) or a cathode ray tube (CRT)). System 12 includes an input device (e.g., a keyboard) and/or a touchscreen 112, a user interface (UI) navigation device 114 (e.g., a mouse), a drive unit 116, a signal generation device 118 (e.g., a speaker) and a network interface device 120.

Drive unit 116 includes a machine-readable medium 122 on which one or more sets of instructions and data structures (e.g., software 108) is stored. It should be understood that the term “machine-readable medium” includes a single medium or multiple medium (e.g., a centralized or distributed database, and/or associated caches and servers) that stores one or more sets of instructions. The term “machine-readable medium” also includes any medium that is capable of storing, encoding or carrying a set of instructions for execution by the machine and that cause the machine to perform any one or more of the methodologies of the present subject matter, or that is capable of storing, encoding or carrying data structures utilized by or associated with such a set of instructions. The term “machine-readable medium” accordingly includes, but not be limited to, solid-state memories, optical and magnetic media, and carrier wave signals.

Instructions 108 reside, completely or at least partially, within first memory 104 and/or within first processor 102 during execution thereof by system 12. Network interface device 120 transmits or receives instructions 108 over a network 16 utilizing any one of a number of well-known transfer protocols.

Network 16 includes a wireless network, a wired network or a combination thereof. Network 16 can be implemented as one of the different types of networks, such as intranet, local area network (LAN), wide area network (WAN), the internet, and the like. Network 16 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 16 includes a variety of network devices, including routers, bridges, servers, computing devices, storage devices, and the like.

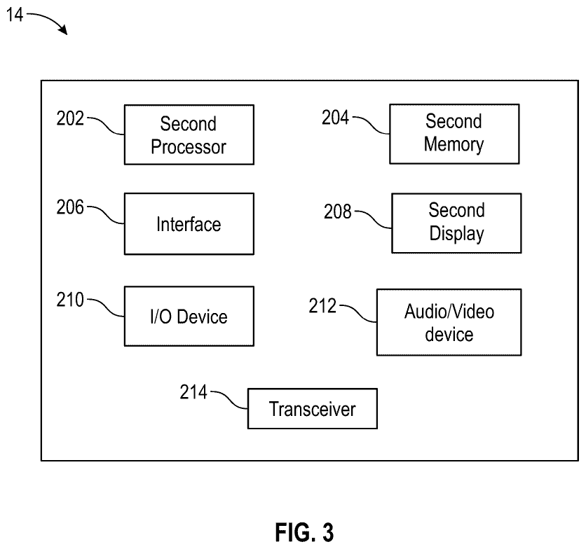

System 12 includes one or more client devices such as client device 14.1, client device 14.2 . . . client device 14.n, collectively referred to as client devices or simply client device 14. Client device 14 indicates an electronic device such as a mobile device, a personal digital assistant, a laptop computer, a tablet computer, a desktop computer etc. In the present subject matter, a retailer or manufacturer or distributor (not shown) operates client device 14. FIG. 3 shows a block diagram of client device 14, in accordance with one embodiment of the present invention. Each of the client devices 14 includes at least one second processor 202. Second processor 202 includes one or more commonly known CPUs such as microprocessor or microcontroller. It should be understood that second processor 202 might be responsible for implementing specific functions under the control of software including an operating system, and any appropriate applications software.

Each of client devices 14 includes a second memory 204 such as a volatile memory (e.g., RAM), non-volatile memory (e.g., disk memory, FLASH memory, EPROMs, etc.), unalterable memory, and/or other types of memory. In one implementation, second memory 204 might be configured or designed to store data, program instructions. The program instructions might control the operation of an operating system and/or one or more applications.

Each of client devices 14 includes interface(s) 206. Interfaces 206 may include wired interfaces and/or wireless interfaces. In at least one implementation, interfaces 206 may include functionality similar to at least a portion of functionality implemented by one or more computer system interfaces such as those described herein and/or generally known to one having ordinary skill in the art.

Each of client devices 14 includes second display(s) 208. Second display(s) 208 may be implemented using LCD display technology, OLED display technology, and/or other types of conventional display technology. Each of the client devices 14 may include one or more user 1/O Device(s) 210 such as keys, buttons, scroll wheels, cursors, touchscreen sensors, audio command interfaces, magnetic stripe reader, optical scanner, etc. Each of the client devices 14 may include Audio/Video device(s) 212. Audio/Video device(s) 212 includes components for displaying audio/visual media. For example, Audio/Video device(s) 212 may include cameras, speakers, microphones, media presentation components, wireless transmitter/receiver devices for enabling wireless audio and/or visual communication between client device 14 and the system 12 and other remote devices (e.g., radios, telephones, computer systems, etc.).

Each of client devices 14 may include wireless communication module(s)/transceiver 214. Transceiver 214 may be configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

System 12 communicates with client device 14 and user device 18 via network 16. In one implementation, user device 18 indicates an electronic device such as a mobile device, a personal digital assistant, a laptop computer, a tablet computer, a desktop computer etc. User device 18 includes all the components and operates similar to client device 14. In the present subject matter, the retailer or manufacturer or distributor operates client device 14. Optionally, a user or customer operates user device 18 to select a component and execute a purchase transaction.

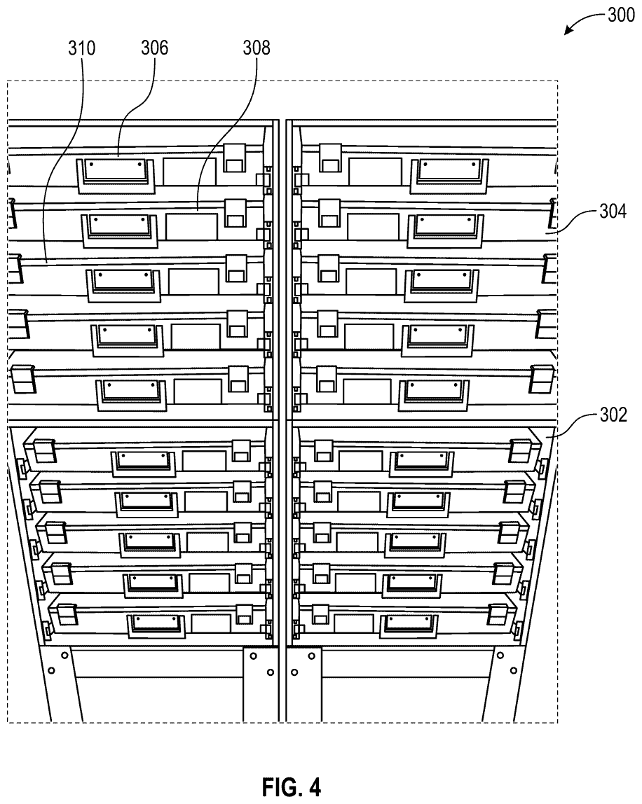

The presently disclosed system 12 provides a virtual assortment interface of components in inventory in an e-commerce environment, which is a replica of an actual container having multiple drawers. FIG. 4 shows a perspective view of a container or storage device 300, in accordance with one exemplary embodiment of the present subject matter. In one example, storage device 300 indicates a storage rack or component organizer or container. Storage device 300 includes a frame 302 extending from the ground, for example. Frame 302 receives a plurality of drawers or storage boxes 304. Plurality of drawers 304 includes a first drawer 306, a second drawer 308, a third drawer 310 and so on. Plurality of drawers 304 is used to store a variety of components. In one example, first drawer 306 stores push pins, second drawer 308 stores hood clips, and third drawer 310 stores expansion fasteners. Plurality of drawers 304 is stacked over one another for easy storage and access to components stored therein. The components include retail products or retail sale articles such as fasteners, clips, pins, blades, clamps, electrical components (e.g., electrical bulbs, switches and fuses), etc. Alternatively, the components can include any merchandise that can be sold by a retailer or distributor, such as apparels, footwear, accessories, raw materials, sport goods, toys or any other goods or services.

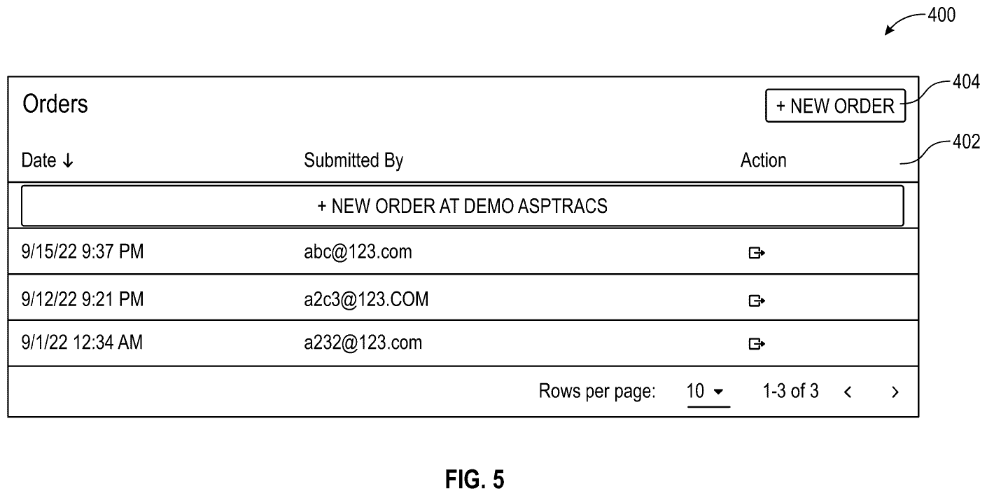

In order to create a virtual assortment of components, at first, system 12 presents a graphical interface 400 as shown in FIG. 5, in accordance with one embodiment of the present subject matter. Here, a retailer accesses graphical interface 400 using client device 14. Graphical interface 400 presents a first section 402 and a second section 404. First section 402 shows a list of orders previously generated. Here, each order represents an instance in which the retailer has added or removed or altered details of components in a drawer of a container, say first drawer 306 in storage device 300. The retailer selects second section 404 i.e., new order in order to add components in one or more virtual drawers.

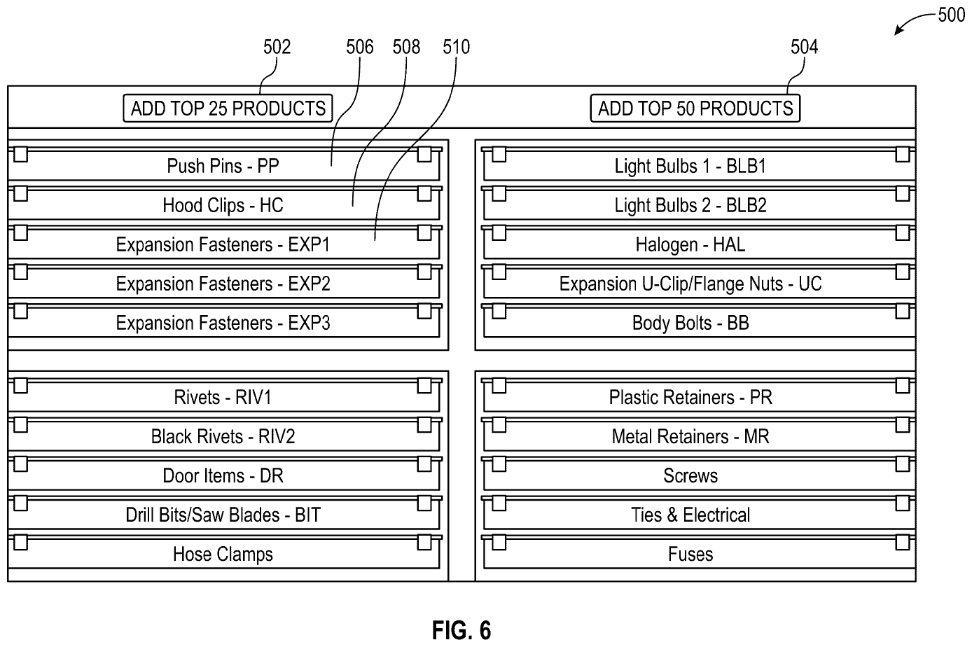

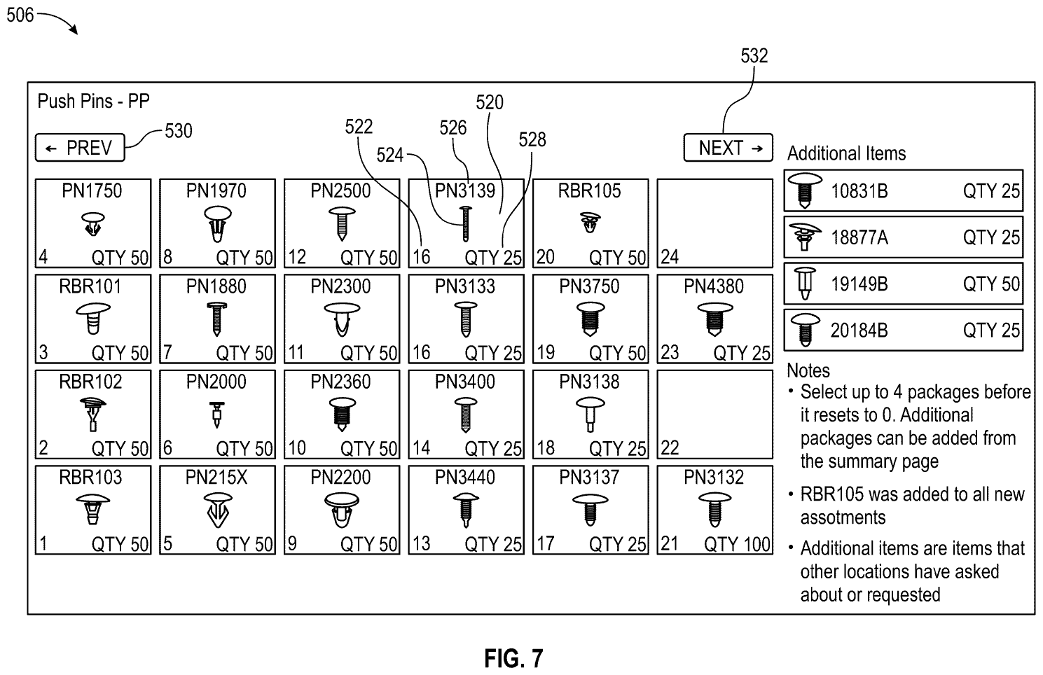

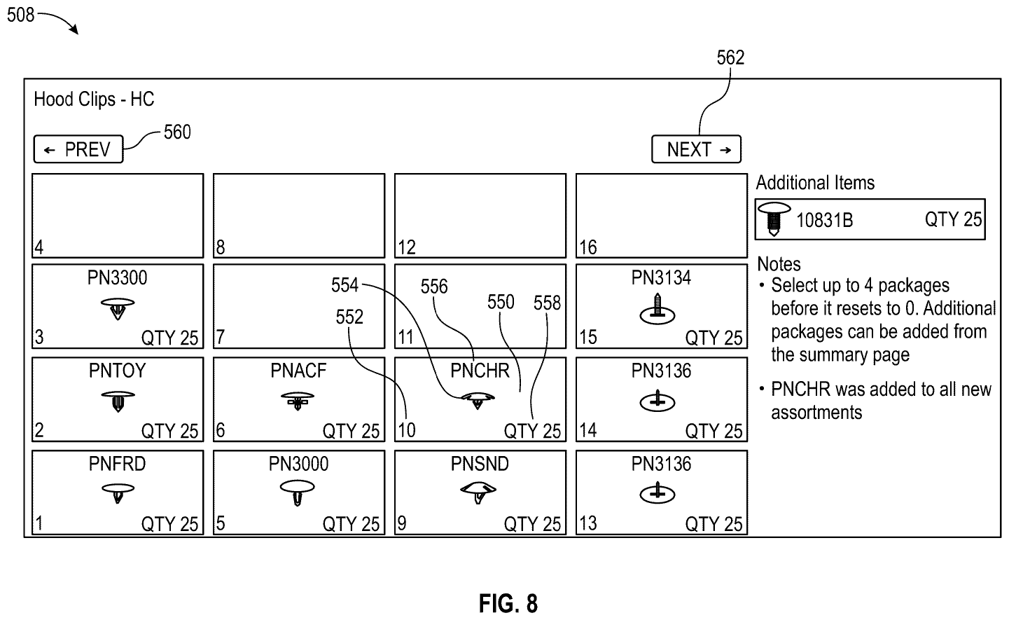

Upon selecting second section 404, system 12 presents a virtual assortment interface 500 to the retailer, as shown in FIG. 6, in accordance with one embodiment of the present subject matter. Virtual assortment interface 500 corresponds to physical storage device 300 placed in a warehouse/inventory of the retailer. Here, virtual assortment interface 500 displays a first section 502 and a second section 504. In one example, first section 502 is configured to present the top 25 products. Further, second section 504 is configured to present the top 50 products. Each of first section 502 and second section 504 display a plurality of drawers i.e., a first drawer 506, a second drawer 508, a third drawer 510, etc. Similar to physical drawers 304 in storage device 300, first drawer 506, second drawer 508, and third drawer 510 are stacked over one another. In one example, each of first drawer 306, second drawer 308, and third drawer 310 of storage device 300 is mapped to first drawer 506, second drawer 508, and third drawer 510 of virtual assortment interface 500. This way, the data in virtual assortment interface 500 matches in real-time with the data in drawers 304.

In one embodiment, system 12 allows the retailer to add, amend, or remove the data in virtual assortment interface 500. In order to add, amend, or remove, at first, system 12 receives an input based on retailer's selection. Assume that the retailer selects first drawer 506 in virtual assortment interface 500. In the present example, the retailer selects first drawer 506 to view the components details of Push Pins. Upon selection, system 12 presents a virtual representation of compartments 520 with first drawer 506 corresponding to first drawer 306 in storage device 300. Here, compartments 520 indicate smaller areas/segments/partitions within first drawer 306 for placing components of similar type based on their unique size, serial number, manufacturer, etc. For each compartment, virtual assortment interface 500 displays the number of compartment 522, type of component 524 (push pin) placed within compartment 520, serial number (manufacturer code) of component 524 and available quantity 526 of the component 524 in drawer 506. Further, virtual assortment interface 500 presents previous tab 528 and next tab 530 options in order to navigate to adjacent or top/below drawers.

Consider the retailer selects next tab 530. Upon selection, virtual assortment interface 500 presents a virtual representation of compartments 550 with second drawer 508 corresponding to second drawer 308 in storage device 300. Here, compartments 550 indicate smaller areas/segments/partitions within second drawer 308 for placing components of similar type based on their unique size, serial number, manufacturer, etc. For each compartment, virtual assortment interface 500 displays the number of compartment 552, type of component 554 (Hood Clips) placed within compartment 550, serial number (manufacturer code) of component 556 and available quantity 558 of the component 554 in drawer 508. Virtual assortment interface 500 presents previous tab 560 and next tab 562 options in order to navigate to adjacent or top/below drawers. Consider the retailer selects previous tab 560. Upon selection, virtual assortment interface 500 presents a virtual representation of compartments 520 with first drawer 506. Consider the retailer selects next tab 562. Upon selection, virtual assortment interface 500 presents a virtual representation of compartments corresponding to third drawer 510.

The presently disclosed system 12 allows the retailer to add and/or obtain information about the inventory available in storage device 300 by accessing virtual assortment interface 500. This way, when the components are low in stock, the retailer may receive a notification to restock the inventory. Further, the retailer avoids physical inspection of all the compartments and/or drawers 304 to check for available or required inventory. The presently disclosed system 12 improves operational efficiency for a retailer and/or distributor of components.

In addition, when a user wishes to purchase the components, the user uses user device 18 to access system 12. Here, system 12 presents virtual assortment interface 500 on user device 18. As virtual assortment interface 500 corresponds to the inventory in storage device 300, the user hovers over drawers 506, 508, 510 to view the complete assortment of components. Here, the user selects one or more components using the previous and next tabs and adds the components to a virtual shopping cart. The hovering over multiple drawers on the virtual assortment interface 500 creates a simulation of opening and closing of actual drawers in storage device 300. In other words, the user selects the components by moving from one drawer to another on the virtual assortment interface and adds the components in the virtual shopping cart. This presents a unique shopping experience for the users while providing an improved assortment for the retailers or distributors in managing the inventory. After adding the components, the user executes a purchase transaction. Subsequently, the retailer or distributor fulfils the purchase by shipping the components to the user.

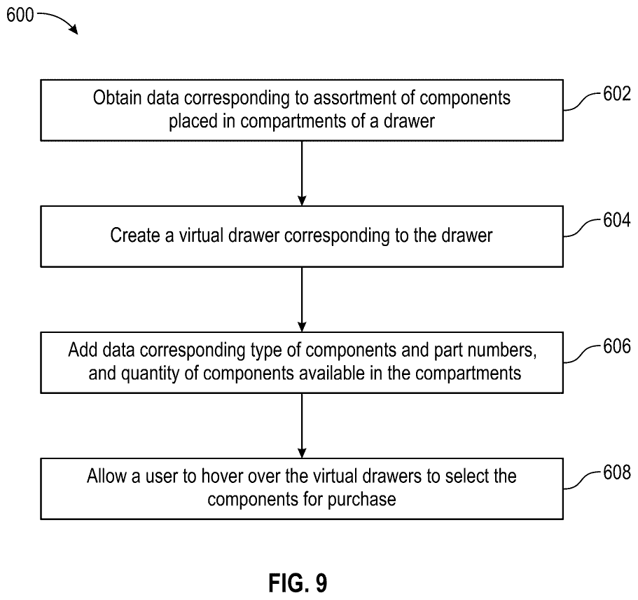

FIG. 9 shows a method 600 for providing a virtual assortment interface of components in inventory in an e-commerce environment, in accordance with one exemplary embodiment of the present subject matter. The order in which method 600 is described should not be construed as a limitation, and any number of the described method blocks can be combined in any order to implement method 600 or alternate methods. Additionally, individual blocks may be deleted from method 600 without departing from the spirit and scope of the subject matter described herein. Furthermore, method 600 can be implemented in any suitable hardware, software, firmware, or combination thereof. However, for ease of explanation, in the embodiments described below, method 600 may be implemented using the above-described system 12.

At first, system 12 obtains data corresponding to the assortment of components placed in compartments of a drawer 304, as shown at step 602. Subsequently, system 12 creates a virtual drawer 506, 508, 510 (virtual assortment interface 500) for each drawer 306, 308, 310, as shown at step 604. Here, virtual drawers 506, 508, 510 are arranged in any order depending on the need or preference of the retailer. For example, virtual drawers 506, 508, 510 can be arranged as per top products, least sold components, perishable products, or any other given criteria.

At step 606, the data corresponding to the number of compartments, type of components, part numbers and the quantity available is added such that the real-time data of each drawer 306, 308, 310 is updated in virtual drawer 506, 508, 510. Subsequently, system 12 allows user devices 18 to access virtual drawers 506, 508, 510 to select the components and add them to a virtual shopping cart for executing a purchase transaction, as shown at step 608.

The presently disclosed system provides several advantages when compared with known art. The system presents an actual virtual version of the storage devices/storage racks that are used to stock components in retail or distribution centers. When the customer or user wishes to purchase/order, the user/customer can see the complete assortment of the components on the virtual assortment interface. Further, the user can then click on the virtual drawer and select the components and add to their shopping cart. The user can customize by adding new items from the same drawer, and/or move from one drawer to another to add further items without performing a typical search as in existing e-commerce platforms.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purposes only and should not be construed in a limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

1. (canceled)

2. A method for providing a virtual assortment interface of components in an inventory in an e-commerce environment, said method comprising the steps of:
obtaining, by a processor, data of an assortment of components placed in compartments of a physical drawer of a plurality of physical drawers, said data corresponding to a number of each compartment, type of components placed within each compartment, a serial number of each of said components and available quantity of said components in said physical drawer;
creating, by said processor, a virtual drawer interface comprising a plurality of virtual drawers corresponding to said plurality of physical drawers;
adding, by said processor, the data of the assortment of components to said plurality of virtual drawers; and
accessing, by said processor, a virtual drawer of said plurality of virtual drawers for selecting and adding a component to a virtual shopping cart for executing a purchase transaction of said component selected.

3. The method of claim 2, further comprising updating, by said processor, the data in said virtual drawer in real-time matching the data in said physical drawer upon executing the purchase transaction.

4. The method of claim 2, further comprising updating, by said processor, the data in said virtual drawer corresponding to said physical drawer in real-time.

5. The method of claim 2, further comprising navigating, by said processor, said plurality of virtual drawers in said virtual drawer interface for selecting a virtual drawer of said plurality of virtual drawers.

6. The method of claim 2, further comprising simulating, by said processor, opening and closing of said virtual drawer in said virtual drawer interface.

7. The method of claim 2, further comprising arranging, by said processor, said plurality of virtual drawers in a predefined criteria.

8. The method of claim 2, further comprising displaying, by said processor, said plurality of virtual drawers in a stacked configuration.

9. The method of claim 2, further comprising generating, by said processor, an alert when corresponding components in said virtual drawer is below or above a threshold.

10. The method of claim 2, further comprising adding, removing or amending, by said processor, the data in said virtual drawer interface.

11. A system for providing a virtual assortment interface of components in an inventory in an e-commerce environment, said system comprising:
a memory; and
a processor coupled to the memory, wherein the processor executes program instructions stored in the memory, to:
obtain data of an assortment of components placed in compartments of a physical drawer of a plurality of physical drawers, said data corresponding to a number of each compartment, type of components placed within each compartment, a serial number of each of said components and available quantity of said components in said physical drawer;
create a virtual drawer interface comprising a plurality of virtual drawers corresponding to said plurality of physical drawers;
add the data of the assortment of components to said plurality of virtual drawers; and
access a virtual drawer of said plurality of virtual drawers for selecting and adding a component to a virtual shopping cart for executing a purchase transaction of said component selected.

12. The system of claim 11, wherein said processor further executes the program instructions stored in the memory, to update the data in said virtual drawer in real-time matching the data in said physical drawer upon executing the purchase transaction.

13. The system of claim 11, wherein said processor further executes the program instructions stored in the memory, to update the data in said virtual drawer corresponding to said physical drawer in real-time.

14. The system of claim 11, wherein said processor further executes the program instructions stored in the memory, to navigate said plurality of virtual drawers in said virtual drawer interface for selecting a virtual drawer of said plurality of virtual drawers.

15. The system of claim 11, wherein said processor further executes the program instructions stored in the memory, to simulate opening and closing of said virtual drawer in said virtual drawer interface.

16. The system of claim 11, wherein said processor further executes the program instructions stored in the memory, to arrange said plurality of virtual drawers in a predefined criteria.

17. The system of claim 16, wherein the predefined criteria comprises one of top components, least transacted components, or perishable components.

18. The system of claim 11, wherein said processor further executes the program instructions stored in the memory, to display said plurality of virtual drawers in a stacked configuration.

19. The system of claim 11, wherein said processor further executes the program instructions stored in the memory, to generate an alert when corresponding components in said virtual drawer is below or above a threshold.

20. The system of claim 11, wherein said processor further executes the program instructions stored in the memory, to add, remove or amend the data in said virtual drawer interface.

21. A non-transitory, computer-readable medium storing instructions that, when executed by a computer system for accessing and using contextual identify information during a law enforcement encounter, configure the computer system for:
obtaining data of an assortment of components placed in compartments of a physical drawer of a plurality of physical drawers, said data corresponding to a number of each compartment, type of components placed within each compartment, a serial number of each of said components and available quantity of said components in said physical drawer;
creating a virtual drawer interface comprising a plurality of virtual drawers corresponding to said plurality of physical drawers;
adding the data of the assortment of components to said plurality of virtual drawers; and
accessing a virtual drawer of said plurality of virtual drawers for selecting and adding a component to a virtual shopping cart for executing a purchase transaction of said component selected.
